(19) United States
(12) Patent Application Publication
(10) Pub. No.: US 2003/0026484 A1
(43) Pub. Date: Feb. 6, 2003

(54) Automated image identification system

(76) Inventor: Mark O'Neill, Oxfordshire (GB)

Correspondence Address: Robert Platt Bell, Registered Patent Attorney, 8033 Washington Road, Alexandria, VA, 22308, US

(21) Appl. No.: 09/842,828

(22) Filed: Apr. 27, 2001

(51) Int. Cl. G06K 9/62

(52) U.S. Cl. 382/224

(57) ABSTRACT

The present invention provides an automatic identification system, capable of discriminating species based on non-apparent differences in wing morphology. An input image to be classified or identified is input and stored. An image pose normalizer is used to image pose normalize the input image to produce an image pose normalized input image. The image pose normalized input image is compared to each of a plurality of sample image pose normalized images in a stored training set comprising the plurality of sample image posed normalized images. At least one of the plurality of sample images which most closely corresponds to the input image may then be displayed. The system of the present invention is ideally suited for a group of insects with apparent, but subtle wing differences, and thus is capable of overcoming the taxonomic impediment hindering the inventorying and monitoring of biodiversity.

### FIELD OF THE INVENTION

The present invention relates to a system for automatically classifying and/or identifying images. In particular, the present invention is directed toward a system for comparing an input image, such as a sampled insect, to a collection of stored images, for classifying purposes.

### BACKGROUND OF THE INVENTION

Image classification systems are well known and have an increasing variety of uses. Probably one of the oldest image classifying systems is the fingerprint identification system used by the Federal Bureau of Investigation to match up fingerprints from suspects and crime scenes to a huge database of stored fingerprint images. Such a system generally requires the use of a powerful mainframe computer or computers to operate. Moreover, such a system generally classifies images based upon unique characteristics of fingerprints (or points). Thus, such a system may not be applicable to other image classifying tasks. Moreover, the size and cost of such a system may be prohibitive for use by non-government agencies and individuals.

Other types of image identifiers have been known in the art. For example, Mann et al., U.S. Pat. No. 6,119,096, issued Sep. 12, 2000, and incorporated herein by reference, discloses a technique for identifying persons by characteristics of the human iris. However, it is not clear whether the system of Mann et al. can be applied to identifying and classifying images other than a human iris. Moreover, it is not clear whether such a system can be implemented on basic computing equipment such as a laptop computer. If an image identification and classification system could be developed which could run on inexpensive computing equipment, many additional applications could be found for such equipment.

For example, inventorying, monitoring and ultimately using biodiversity (e.g., for pharmaceutical prospecting, monitoring endangered species, and the like) all require one to be able to recognize the species present. However, despite two centuries of taxonomic activity the overwhelming majority of species in most ecosystems are more or less unrecognizable, except by a few highly trained specialists. Very few taxonomic experts have the skills necessary to recognize a wide range of taxa, and their numbers are declining.

Traditional applied taxonomic products dichotomous identification keys are often almost impossible to use without adequate reference collections, comprehensive literature sources and an extensive knowledge of arcane specialist terminology. Even where keys for the identification of a group of organisms exist, many biologists may not use them. Biologists may not use such keys as many non-specialists have not honed their skills for perceiving many of the subtle differences used by taxonomists to discriminate species.

Thus, for example, it would be desirable to provide a system for inventorying, identifying, and classifying new species of flora and fauna which does not require the intervention of an expert in the field. For example, for a given species of insect, there may be only a few dozen experts in the world with sufficient expertise to classify such insects. Unfortunately, most of the unknown and unclassified species left in the world may be located in remote and inaccessible areas (far-off jungles, rain forests, and the like). Even more distressing is such areas are being rapidly developed.

Thus, many species of flora and fauna are becoming extinct before they can be identified, classified, investigated, or otherwise studied. The exact number of such species becoming extinct is largely unknown, as the skilled manpower available to classify such species is minuscule and the task Herculean. Thus, it would be desirable to employ a larger workforce of less skilled persons in the field, provided with an automated and portable system to investigate, identify, classify and otherwise study such species.

Such a system, if developed, could have many other applications beyond identifying species of flora and fauna. General applications for such an image identification and classification system may include medical applications such as analysis of tissue preparation, identification of hair line fractures in X-ray imagery of bones, analysis of MRI imagery, and the like. In addition, the present invention may also be applied to security applications such as facial recognition, iris recognition, fingerprint recognition, identification of individuals from DNA fingerprints).

The present invention may also be applied to remote sensing applications such as ground cover type classification, identification, and subsequent tracking of tropical cyclones and the like. Military applications may include recognition of aircraft and military vehicles in battlefield scenarios, identification of high flying aircraft from contrail emissions and the like. Life science applications may include biodiversity screening, species identification from phenotype, part phenotype, DNA fingerprint or SDS protein gel fingerprint.

### SUMMARY OF THE INVENTION

This present invention provides an innovative and novel method for overcoming the taxonomic impediment hindering nations wishing to implement Article 7 of the Convention on Biological Diversity. It is thus a Darwin project, as it uses British skills and computer software to provide the means for biodiversity-rich countries to inventory and monitor their own biodiversity. By providing a working system for automatic identification of a target group of insects, the present invention helps to develop in the partner country the skills necessary to extend image analysis techniques to a far wider range of organisms than just the target groups.

The system of the present invention may be automated and accessible over the INTERNET, and may thus be available to a wide range of users both in other institutions in a partner country, and elsewhere in the region. Furthermore, diagnostic images of specimens held in the Natural History Museum may be accessible to workers in overseas institutions, thus providing a novel form of improving access to data held in UK institutions, which is one need highlighted by the Darwin Committee. The system effectively captures taxonomic information and expertise permanently.

The system of the present invention may be particularly cost-effective as it removes the need for countries to develop expensive reference collections of fragile, perishable material, and duplicate taxonomic skills found elsewhere. The Darwin logo may be used in the opening screens as users access the system.

It is one objectives of the present invention to provide an operational automatic identification system which allows non-specialists to identify species of a target group of insects, and thus permit wide participation in processes designed to inventory and monitor biodiversity.

It is further object of the present invention to provide a system which helps develop the skills necessary in the partner country which enables collaborators to use the software to create automatic identification systems for other organisms.

It is a further object of the present invention to provide a simple and cost effective method which allows wide accessibility to diagnostic image-based specimens held in a collection.

The taxonomy of one group in question, Ophioninae, is reasonably sound and a traditional key may be available for identifying the fauna throughout a region. However, species discrimination of ophionines may be extensively based on minute differences in the shape of wing parts, differences which subsequently have proved to be very difficult for a non-specialist to appreciate. Consequently, in the various faunal surveys being undertaken by university students and others, great difficulty may be experienced by people attempting to identify species using this key, and their success rates are very low.

The problem may not be one of inadequate taxonomy (although there are some new species), it may be one of user inexperience. This problem results as non-specialists are simply not able to perceive the very fine differences used for species segregation. This may be a very common difficulty with taxonomic products, and may be a barrier which is perhaps not widely appreciated unless taxonomists work with groups of users. Years of experience hone a taxonomist's ability to perceive subtle differences in shape or curvature far beyond the level most untrained persons have.

Clearly, there is a need for a new type of product with which to do identification, one which does not require the user to gain a great deal of familiarity with the target organisms before they can confidently identify them. Modern computer technology, using machine vision techniques, offers a potential solution to this problem

The present invention provides an automatic identification system, capable of discriminating species based on non-apparent differences in wing morphology. The system of the present invention is ideally suited for a group of insects with apparent, but subtle wing differences, and thus is capable of overcoming the taxonomic impediment hindering the inventorying and monitoring of biodiversity.

### BRIEF DESCRIPTION OF THE DRAWINGS

FIG. 1 is a screen shot illustrating a graphical user interface (GUI) of the present invention.

FIG. 2 illustrates typical page of HTML generated by DAISY.

FIG. 3 is a block diagrams illustrating the operation of the DAISY classification system of the present invention.

FIG. 4 illustrates DFE output with multiple overlay objects.

FIG. 5 illustrates a Digital Terrain Model (DTM) of Central Greece generated by ITG from SPOT PA imagery.

FIG. 6 illustrates a typical DAISY information web page.

FIG. 7a illustrates various wings of Culex pipiens pipiens (Linaeus).

FIG. 7b illustrates various wings of Culex pipiens molestus (Forskal).

FIG. 8 illustrates a specimen of Xylophanes chiron (Drury) a) and its subsampled IPM transform b). In this case the fovea is the center of image a.

FIG. 9 illustrates the relationship between (poly)ROI and fovea (for IPM algorithm).

FIG. 10 is a schematic of the circular rotation operations (used to apply lead or lag) prior to auto correlation illustrating the concept of a circular image rotation in the contact of IPM auto-correlation.

FIG. 11 illustrates an actual (mean) classifier partition function for Enicospilus cameronii (Dalla Torre).

### DETAILED DESCRIPTION OF THE INVENTION

The present invention comprises a novel computerized system for undertaking large scale taxonomic identifications. The present invention may be referred to as DAISY (Digital Automated Identification SYstem). The DAISY GUI may be implemented under WINDOWS 3.11 or higher on a Pentium-based Personal Computer (PC) which may also runs an image processing and analysis system which acquires imagery to be identified. Of course, other types of operating systems (MacIntosh, Unix, Linux, or the like) may be used within the spirit and scope of the present invention.

Using DAISY, trained on a small number of images of wings of different species, high levels of accuracy in identification (e.g., greater than 90 percent) have been achieved. DAISY provides a high degree of promise for automation of routine identifications, thus removing the taxonomic impediment to those wishing to implement Article 7 of the Convention on Biological Diversity, and develop sustainable uses for biodiversity. It provides an approach to both reducing pressure on taxonomists, and to capture, for wide dissemination, the huge quantity of information embodied in the taxonomic collections of major museums.

In an initial application for the present invention, DAISY may be implemented, building on established collaborative links with the Escuela de Biologia (University of Costa Rica). Costa Rica is considered to be an ideal target country as there is considerable biological inventory activity there which may rigorously use and test the system. Collaboration may extend to include the Escuela de Informatica, ensuring the technology transferred may continue to be developed and applied to the problems encountered in a biodivervse-rich tropical country.

The target group of insect to be identified which has been selected is the Ophioninae (Hymenoptera: Ichneumonidae). These were chosen because they are a large and representative insect group of around 100 species. Moreover, considerable experience is available in discriminating the species of this group especially in the study area, and the basic taxonomic problems have been resolved although a few new species may be found.

Furthermore, the species may be recognized primarily on the basis of subtle differences in the wings, differences which are both difficult to express and difficult for a non-specialist to appreciate, even when good photographs are to hand. In addition, there is an active group of scientists in Costa Rica who, in the course of their studies on biological diversity, may have cause to and are willing to use the system. As several of these species are important enemies of agricultural pests, the system may be used beyond the inventory/monitoring activity sphere.

In order to be able to cope quickly and efficiently with large numbers of internet-based identification queries in a reasonable time scale (target turnaround time of <1 minute per enquiry) the DAISY system of the present invention has been implemented in an POSIX.1b environment using the ANSI C programming language. The present invention makes use of the PUPS distributed programming environment and has been designed from the outset a loosely coupled MIMD system.

From a computational standpoint two features of the DAISY system of the present invention are of particular interest; the use of homeostatic and evolutionary mechanisms within DAISY in order to make the system fault tolerant, and the distributed implementations of DAISY which may fail gracefully in the event of hardware failures on the platforms running components of the system. The form of task distribution used by the DAISY system of the present invention is highly novel and modelled loosely on protein transport and immunological responses in eucariotic cells.

Information which is to be processed by components of the DAISY system of the present invention are tagged with key codes. These key codes may cause components of the DAISY system which are sensitized to the data to read it in process (and if necessary re-tag it for down-stream processing by other DAISY components). DAISY image data may be tagged in an arbitrary manner using the ftag tool.

The DAISY system of the present invention may comprise four components; DPE, poser, floret, and vhtml. DPE is a graphical front-end which may be based upon the GTK+/Gnome X toolkit. The DFE front-end may used to capture image data (e.g., via a CCD camera attached to a microscope) DFE may then tag this data as either training images or unknown images and feeds the data to the next component of the DAISY system, the poser.

The function of the poser is to normalize the input imagery and also to re-sample it to a standard size prior to classification. The power may be sensitized to appropriately tagged input imagery. When such imagery is found it may extract a region of interest (ROI) using an ROI file which has been associated with the input image by the DFE. The resulting pose-normalized and re-sampled image may then be appropriately tagged for the next component in the DAISY system, the floret.

The floret is the component of the DAISY system which actually classifies unknowns. The floret application is multi-threaded, meaning multiple floret processes, may be run on different physical host computers and may co-operate in classifying unknowns, thus speeding up the DAISY classification process. In keeping with the botanical naming conventions of the DAISY system, this multi-threaded collection of florets is known as an inflorescence. The floret application identifies the unknown if it can. If the unknown can be identified, it is tagged for downstream processing by the vhtml application, otherwise, the unknown image is simply discarded.

The vhtml takes identification tags (inserted into the image file by the floret subsystem and interrogates a database in order to see if there is any information available on the organism. If there is, the vhtml builds a page of virtual HTML using the information mined from the database which it may then display via a slaved netscape client. In addition to being sensitized to the output tags of the floret classifier subsystem, the vhtml client may also be sensitized to a user terminal. Data on the organism identified may be sent to this terminal via a slaved netscape client or other internet client.

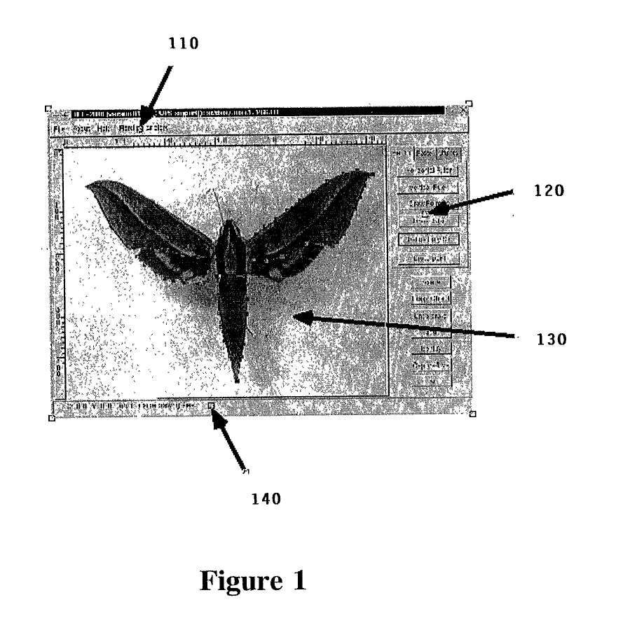

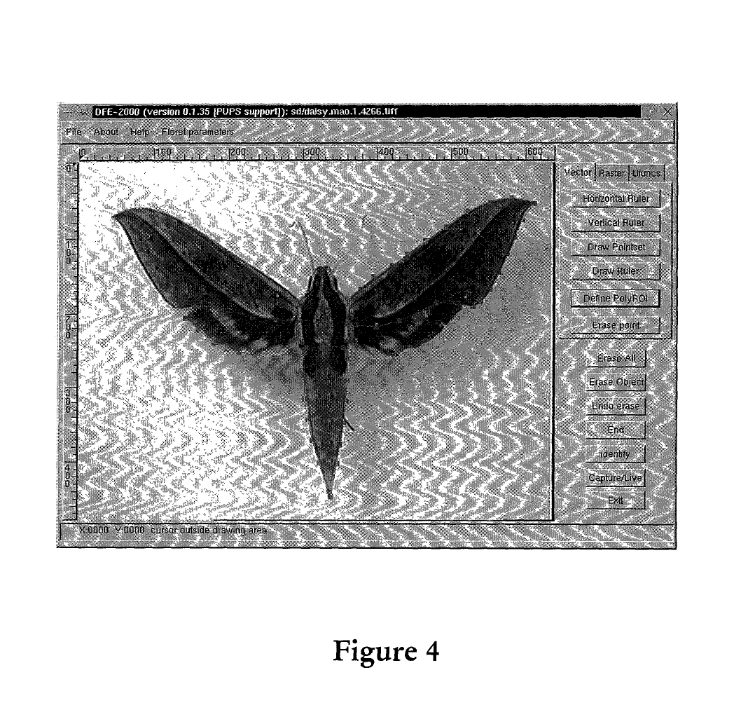

FIG. 1 is a screen shot illustrating the major elements of a graphical user interface (GUI) of the present invention. FIG. 4 illustrates DFE output with multiple overlay objects in more detail. The DFE GUT was written using the GTK+ and Gnome X toolkits (See, e.g.1 Pennington H, GTK+/Gnome Application development, New Riders Publishing, Edn. 1, ISBN 0-7357-0076-8, 1999, incorporated herein by reference). As illustrated in FIG. 1, an image canvas 130 may be provided for displaying stored images, which may comprise images from a database, or images of a specimen to be classified, the latter of which may be generated in the field by a user with a CCD camera and microscope coupled to a is laptop computer running the DAISY software.

Status panel 140 may provide information on the operational status of the program or other program features. As illustrated in FIG. 4, for example, status panel 140 illustrates present cursor position. Buttonbox panel 120 may provide for functions which may be performed by the user (image capture, image store, classify, and the like). Tag menu 110 may provide the user with additional pull-down menus to perform various maintenance functions (as well as some or all buttonbox functions) and allow the user to associate data with a particular image.

Buttons on buttonbox panel 120 may actually change color or turn a different shade of the same color when pressed. Errors may be displayed by writing appropriate messages to a small command/status window below the main DFE image canvas. In an alterative embodiment, error messages may be presented via a Gnome dialogue box. Tag menus 110 presented by DFE may include the Floret parameters menu, which may allow a user to view, setup, or adjust image tags used by the DAISY classifier engine. The Floret parameters menu may be represented by a single form so a user may both view tag status and change tags without having to use a large number of keystrokes or mouse clicks.

User-level documentation (HTML format) may be provided from Tag menu 110 in order to support a help menu option. The mechanism for assigning colors to overlay objects may be accessed via vector and raster buttons in buttonbox panel 120. In one embodiment of the present invention, the DFE of FIGS. 1 and 4 may work with a display has at least eight bit planes. However, the DFE made be made to work with a wide variety of X displays.

Other features may be added to the DFE frontend in order to reduce operator workload and to facilitate data capture. In particular, useful image processing algorithms may be bundled into the DFE code to accomplish a number of image manipulation tasks. The DFE may incorporate a facility to magnify portions of an image to facilitate the task of highlighting the edges of (polygonal) objects (such as insect wing envelopes) using the DFE polyROI functionality. This magnification facility may be internal to the DFE application. If a portion of, for example a 640×480 CCD image is magnified, and the user writes the zoomed image, the DFE application may actually write a image 640×480 pixels in size.

DFE functionality may also include built-in algorithms to eliminate the background portion of an image (e.g., all pixels not in the object which is to he identified are set to a pre-defined value e.g., 0 or 255). Because of the nature of the edge of wing envelopes (particularly when transparent wings are imaged) the preferred methods of delineating the (wing) object may comprise either a snake or a caterpillar edge tracking algorithm combined with a statistical edge detector (See, e.g., Scahbel and Arridge, Active contour models for shape description using multiscale differential invariants, Proc. British Machine Vis. Conf. 1995, 197-206, incorporated herein by reference. Conventional edge extraction algorithms based on intensity gradient (See, e.g., Canny J. F, A Computational Approach to Edge Detection, IEEE Trans PAMI 8(6):679-698, 1986, incorporated herein by reference) may also be used, but may not be sufficient.

In one embodiment, a simple background pixel thresholder similar the Free Software Foundation GIMP image processing package may be used. However, background elimination via this route may require iterative (manual) thresholding. Users may then be able to implement plug-in image processing modules via the PUPS/PSRP API.

Some basic dynamic plug-ins may also be provided. For example algorithms which weight the image in the neighborhood of intensity discontinuities (e.g., to increase the weighting of small, but important features such as veins, small spots, and the like in insect wings). The background elimination algorithms described above may also be provided in the form of dynamic plug-ins.

A DFE frame-grabber code may be provided as an X server side resource so the frame-grabber may be accessible from the display, which is the computer at which the user is sitting (and actually interacting with DFE). Alternatively, the frame-grabber may comprise an X client side resource, meaning the frame-grabber may be physically located on the server. While this is not an issue for networked LINUX/UNIX systems it may be an issue if DAISY is being accessed from PC clients.

One embodiment of the DFE may be provided as a stand alone application which does not make use of the PUPS environment. However, in a preferred embodiment of the present invention, the DFE may be integrated with the PUPS libraries so as to have a look and feel which is more consistent with the rest of the DAISY application, and also give DFE the ability to import dynamic function via the PUPS PSRP API. The addition of a dynamic programming interface to DFE may permit users to customize the DAISY package to suit their particular requirements. For example, the front end processing required to deal with SDS-protein gel images may be quite different to the front end processing which is required to deal with images of insect wings.

The DPE frontend may be run on clients which support the X windowing systems (X11R6) and have GTK+ and Gnome libraries. However, such an embodiment may limit DAISY to systems which are running some flavor of the LINUX UNIX clone on Intel-compatible, SPARC, MIPS or Alpha based hardware. Thus, in an alternative embodiment the X based DFE application may be re-implemented as a JAVA client. Such a Java client may be capable of running on a Windows PC provided it has the (public domain) Java Runtime Environment (JRE) loaded, Alternative methods of delivering DAISY to a client may be provided. For example, the frame-grabber code used by DFE could be made an X server resources and thus DAISY could be delivered to a Windows PC client using a X emulation package for Windows (e.g., the commercial vista Exceed package).

The DAISY classification engine may include three software components. All the components of the DAISY classification engine may be PUPS/PSRP compliant processes which use the novel PSD (PUPS Sensitive Directory) interface for inter-process communication. Because the DAISY classification engine components utilizes the PUPS PSD inter-process communication interface they may be scalable (across clusters of networked workstations). In addition the PUPS PSRP API permits interactive plug and play modification of all the DAISY components.

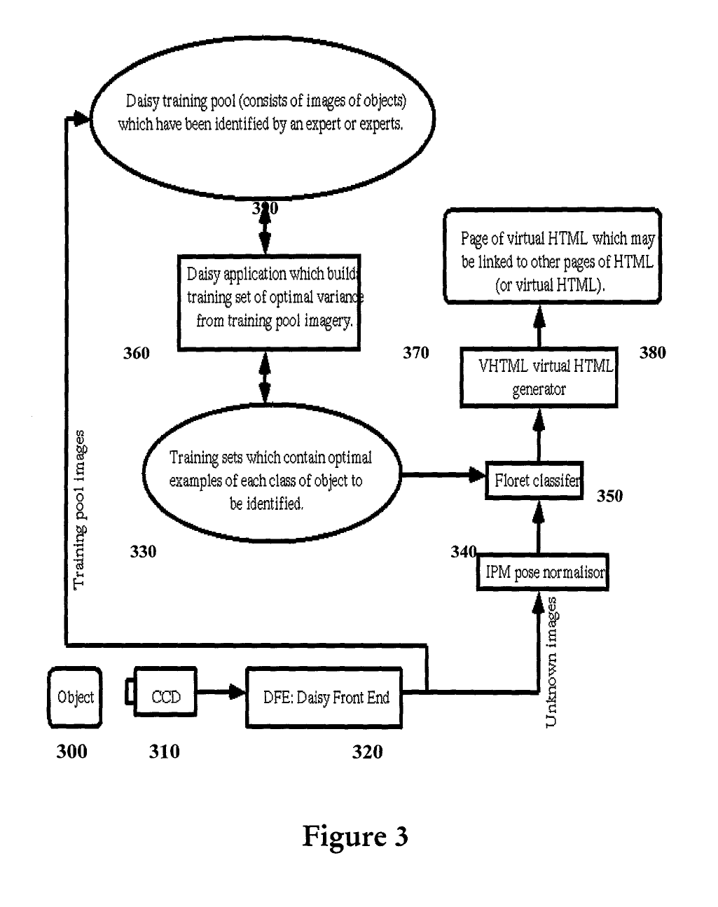

FIG. 3 is a block diagram illustrating the DAISY classification system The DAISY training pool 390 may comprise a library of images of object which have been identified by an expert of experts which are representative of the objects to be identified or classified. In step 360, a training set pruning algorithm optimizes the training sets used by DAISY to build a training set of optimal variance, creating a training set 330 which contains optimal examples from each class of object to be identified.

An optimizing training set pruner may be an essential component of any commercial implementation of DAISY as it may select a subset of training images 330 (from a much larger pool of training images 390) which maximizes accuracy of identifications made by the system while minimizing the corresponding computational throughput. An appropriate algorithm (which stochastically maximizes the global variance of the training set) has been designed as a PUPS/PSRP/PSD application. A schema for the training set pruning algorithm 360 is discussed in more detail below.

Standard images for entry into the DAISY training pool as well as subject images to be classified or identified may be captured using the same or similar technique, as illustrated in FIG. 3. Object 300 may be placed before a CCD camera 310, which may comprise a high resolution camera and/or microscope and stage as well as lighting apparatus. A uniform colored background (e.g., white or a chroma-key color) may be used to maintain consistency between images. The DFE DAISY front end 320 may capture and display these images on the display screen of a Personal Computer or portable laptop. The user can adjust or re-take the images based upon the displayed image.

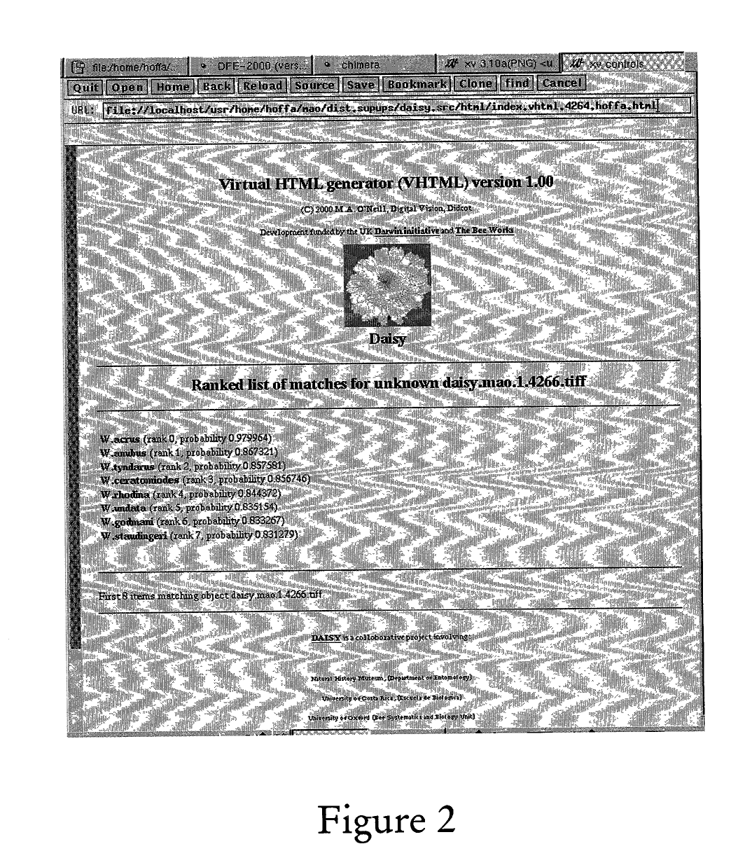

For standard (identified) images to be added to the Training Pool, output of the image passes to the DAISY training pool 390 and may be pruned in step 360 to create an optimal training pool 330 as discussed above. For images to be classified or identified, the image may be passed to IPM normalizer 340 for image normalization. Normalized images may then be passed to floret classifier 350 for classification and identification. A list of likely identification candidates and their probability of accuracy is then generated by VHTML generator 370 for display as a page of virtual VHTML 380, as illustrated in FIG. 2.

Image (rotational) pose normalizer, IPM is illustrated as element 340 in FIG. 3. The purpose of IPM is to transform (rotated) DAISY input imagery into a form which is invariant to rotation. Normalization may be achieved by transforming the input (TIFF) imagery from Cartesian to Rectangular Polar Co-Ordinates, and computing an auto-correlation function of the polar image. IPM 340 may work with overlay object tag-files generated by DFE (via the ROI and polyROI image-region definition directives). Once the image has been pose normalized it may be marked with a tag which forces the floret classifiers to try to identify it. A schema describing the pose normalization methodology employed by IPM is described in more detail below.

The DAISY classifier application, floret is illustrated as block 350 in FIG. 3. Floret may use an algorithm based on the Lucas n-tuple nearest neighbor classifier in order to identify an unknown image (See, e.g., Lucas S. M, Face Recognition with the continuous n-tuple classifier, Proc. British Machine Vis. Conf, 1997, Ed: A. F. Clark, ISBN 0-952-18987-9, 1997, incorporated herein by reference which is itself a derivative of earlier work, See, Alexander, I. and Stonham T., Guide to pattern recognition using random-access memories, IEEE Proc. On Computers and Digital Techniques, 2:29-40, 1979, also incorporated herein by reference)

In principle the algorithm used by floret classifier 350 is simple. The unknown may be correlated with training images which may contain examples of each class of object known to the system. These correlations may be used to produced an ordered list of possible identities. The unknown object may be deemed to be most like the object at the head of the list. This list may then be added to the header data of the unknown image, which is also marked with a tag which forces the VHTML subsystem to generate a page of HTML describing the identified object(s) which may be displayed to the user (via an HTML browser, e.g., Chimera or Netscape which is launched by the VHTML subsystem). The correlation mechanisms used by DAISY are discussed in more detail below.

The virtual HTML generator VHTML 370 takes an ordered list generated by floret classifier(s) 350 and uses it to generate a page of virtual HTML 380 which may displayed using an HTML browser such as Chimera or Netscape. FIG. 2 illustrates typical page of HTML generated by DAISY. If there is no information about the possible identity of the unknown, the page of virtual HTML 380 may simply displays an ordered list to the user. If (HTML) data is available for any of the items in the ordered list VHTML makes a link to it (e.g., the user can find out about a given item by clicking on it).

An imaging tagging utility, ftag may be provided to allow the user to display and or alter image tags which are used by the programs which form the DAISY classification engine to control dataflow through the system.

A library floretlib may be provided as a PUPS format library which may contain functionality common to the component programs of the DAISY classifier engine. In particular, floretlib may implements the PSD (sensitive directory) interface which may be the primary mechanism of inter-process communication for the components of the DAISY system, and the extended TIFF format which is used to store both training set and unknown images. The principal extension to the TIFF format implemented in floretlib is a set of fields accommodating the PSD control tags. The PSD mechanism is described in more detail below.

An algorithm, may be provided to report on the probable accuracy of the DAISY system in identifying a given set of object classes. Such an algorithm may comprise, for example, a PUPS/PSRP/PSD application which may use all the training set/pool images available to the DAISY system to compute prior identification accuracies for each class of object. These probabilities may then be used to compute statistics which are of potential use to the user, (e.g., First Past The Post (FPTP) classification probabilities, screening coefficients, and the like). Such statistics may be displayed to the user through the DAISY front end DFE 320.

The work-packages described above may also include several additional features which may be added to the system in order to increase its functionality and/or the ease with which it may be used. Such additional features may include an IPM application modified to permit aggregate DAISY input files generated from multiple regions of interest within an unknown image to be presented to the floret classifier system. In addition, a GUI interface may be provided for the ftag utility. This GUI interface for the ftag utility may be implemented as a form using an appropriate X utility (for example, Tcl/Tk or Python). In an alternative embodiment, a JAVA-based interface may be required in order to access tools like ftag from Windows-PC clients.

An alternative identification strategy may be implemented based on classifier partition functions which may be generated using the prior probabilities computed by the tools mentioned above which compute accuracy statistics using pre-identified training imagery. One major advantage of the mixture classifier method is it provides a metric which directly measure the significance of a given classification. The algorithms for generating and using classifier partition functions within DAISY are described in more detail below.

The DAISY insect recognition system may make extensive use of the Portable UNIX Programming System [PUPS]. PUPS is a system of libraries (written in ANSI-C) which are designed to facilitate building bio- and neuro- informatic applications (such as DAISY) on operating systems which support POSIX.1b compliance. At the present time, the PUPS libraries are open-source protected by the Free Software Foundation, and may be downloaded from the PUPS website (http://www.pups.org.uk). The PUPS libraries provide extensive support for many kinds of computational problems which are encountered in bio- and neuro- informatic applications.

For example, the PUPS libraries may provide support for persistence. Bio- and neuro- informatic computations such as DAISY may typically have to run for weeks months or even years. Such applications may therefore benefit from mechanisms which allow the user to interact with running processes, mechanisms which allow processes to protect both themselves (and data which is valuable to them) against accidental or malicious damage, and mechanisms which allow running processes to freely migrate between nodes within a computational cluster without loss of context. As described by O'Neill M. A. and C-C Hilgetag, (PUPS—A computational environment for the dynamical representation and analysis of complex neurobiological data, Phil. Trans. Roy. Soc. Lond. B, in press, 2000, incorporated herein by reference) PUPS provides support for all of the above mechanisms.

PUPS further provides support for plug and play applications. PUPS provides a dynamic interface (with strong type checking) which allows the functionality of running processes to be dynamically modified and/or changed. PUPS provides direct support for the sort of complex (e.g., tangled) inter-object relationships which often arise when biological systems are either modelled or databased, via a novel network-wide persistent objects. These objects may be implemented in the form of a global self repairing shared memory which uses a thread-safe malloc model.

In order to provide an adequate of support for commercial implementations of the DAISY and ITG systems it may be necessary to upgrade PUPS as follows. Support for secure transmission of data between PUPS applications (irrespective of whether the PUPS applications are running on the same host, or on different hosts within a computing cluster) may be required. Support for process migration and low latency network file systems has been developed by the MOSIX Research Group at the Hebrew University of Jerusalem under the direction of Professor Amnon Barak.

PUPS may be tightly coupled to MOSIX which is a kernel-level process migration/parallel computation environment which has been developed over the last decade by the Hebrew University of Jerusalem (See, e.g., Barak A and O. La'adan, The MOSIX multicomputer operating system for high performance cluster computing, J. Future Generation Comp. Sys. 13(5-5):361-372, 1998 incorporated herein by reference). Migratory applications built using PUPS/MOSIX may be able to make better use of computing resources within work station clusters.

Support for process checkpointing may be essential if PUPS is to support fault tolerant applications, as it permits processes which are running on a machine which crashes to be restarted with a minimal loss of context. The PUPS checkpointing extensions are based on The University of Tennessee Checkpointing Library (See, e.g., Plank J. s, M. Beck, G. Kingsley and K Li, Libcktp: Transparent checkpointing under UNIX, Proc USENIX Winter 1995, New Orleans, La., 1995, incorporated herein by reference) and are currently being implemented by the MOSIX research group at The Hebrew University of Jerusalem.

The standard client which may be used for interacting with PUPS/PSRP processes may need to be provided with a (form based) GUI. This may be achieved using the public domain Tcl/Tk or Python X GUI authoring packages.

In addition to the DAISY system there are several other potential software products based on the PUPS software environment to which DAISY may be applied. These additional software products may include, for example, seriate and cluster DNA sequencing/molecular taxonomy packages, an ITO (Image To Ground) digital elevation model generator, and seriate and cluster DNA sequencing/molecular taxonomy packages.

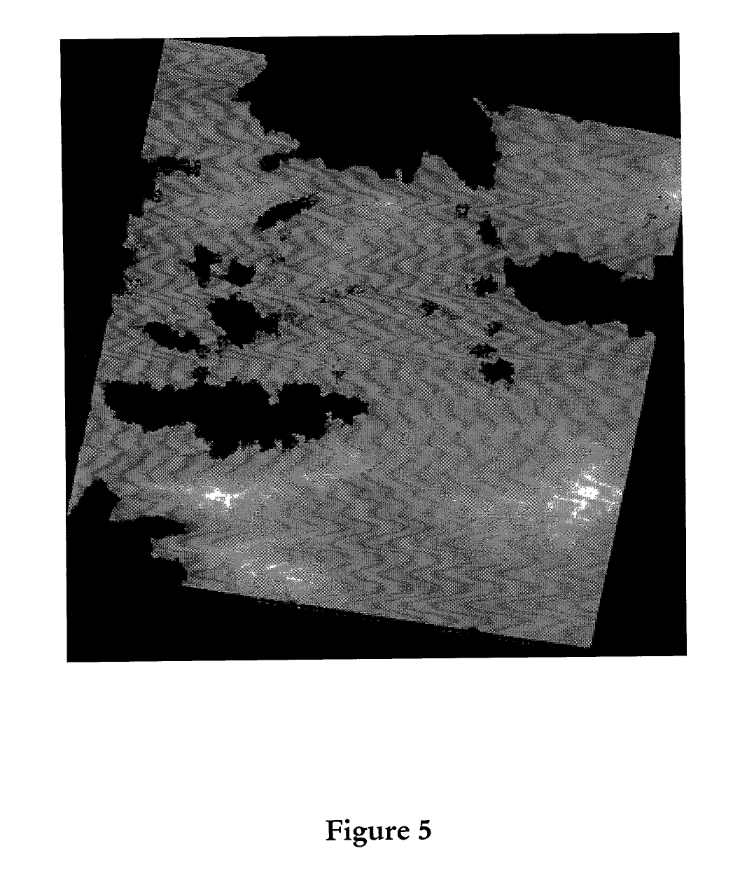

FIG. 5 illustrates an example of a Digital Terrain Model (DTM) of Central Greece generated by ITG from SPOT PA imagery. The DAISY system of the present invention may be applied to such images to identify land masses and/or to identify types of geographical or geological formations and patterns. The ITG digital elevation model generator (See, e.g., O'Neill M. A. and M. I. Denos, Automated system for coarse to fine pyramidal area correlation stereo matching, Image and Vision Comp, 14, 225-236, 1996, incorporated herein by reference) may be embodied using the DAISY software of the present invention The function of the ITG system is to produce topographic maps from a variety of sources of stereo imagery including optical satellite imagery and various forms of aerial photography.

Therefore, ITC based products may be used to augment the capabilities of currently available GIS systems (e.g., IGIS, GRASS, ARCinfo etc.). The application is also suitable for generating large scale 3D models of objects which have been imaged using a vision cell (which means the ITG package could potentially be used in a number of medical, industrial and research applications) The ITG system may be used with the SPOT and ASTER sensors. Some work has been done building other sensor models, for other embodiments, at least an aerial photograph (central perspective) and stereo radargrammetric camera models (egg., for ERS-1, SIR, and other synthetic aperture imaging radars) may be required.

There amy be considerable potential for marketing the ITG DTM generation system as both a stand alone product and as an embedded component within OEM systems (e.g., Laser-Scan IGIS product) and also services based on it (e.g., generation of DTM products as part of GIS services). In addition, the ITG system could be bundled into a complete data acquisition system for large scale imagery.

User level documentation may be provided to permit a non-technical user (e.g., Entomologists and other biologists) such that DAISY may be uses effectively. Technical Manuals may provide the more technical user with sufficient information to customize the system. In particulars this level of documentation may be targeted at systems administration staff tasked with installing packages like DAISY and ITG on work station clusters and similar environments.

In addition to application documentation, in the case of the DAISY as implemented as an insect recognition system, documentation (in the form of pages of HTML) may be provided for each class of object which the system may identify, The bulk of such documentation may be provided by customer organizations building DAISY training set databases for their target application. Thus, for example, the DAISY system may be utilized by a customer for an image recognition or classification system or the customer's own design. In addition, a number of documented example databases may be provided with the DAISY product.

Examples of such data sets may include Xylophanes (Lepidoptera: sphingidae), Hyles (Lepidoptera: sphigidae), Automeris (Ledidoptera: saturnidae), Rothschildia (Lepidoptera: saturnidae), Enicospilus (Hymenoptera: ichnumonidae), Bombus (Hymenoptera: apidae) and Ceratopogonid (Diptera: ceratopogonidae) datasets. Typical examples of the sort of data pages required is illustrated below. Further examples of the types of data pages which may be used are disclosed, in Pittaway A. R, The Hawkmoths of the Western Palaeartic, Pub. Harley Books, Edn. 1, ISBN 0-946589-21-6, 1993, and A survey of the ophininae of tropical Mesoamerica with special reference to the fauna of Costa Rica, Bull. Brit. Mus. Nat. Hist, 57(1), both of which are incorporated herein by reference.

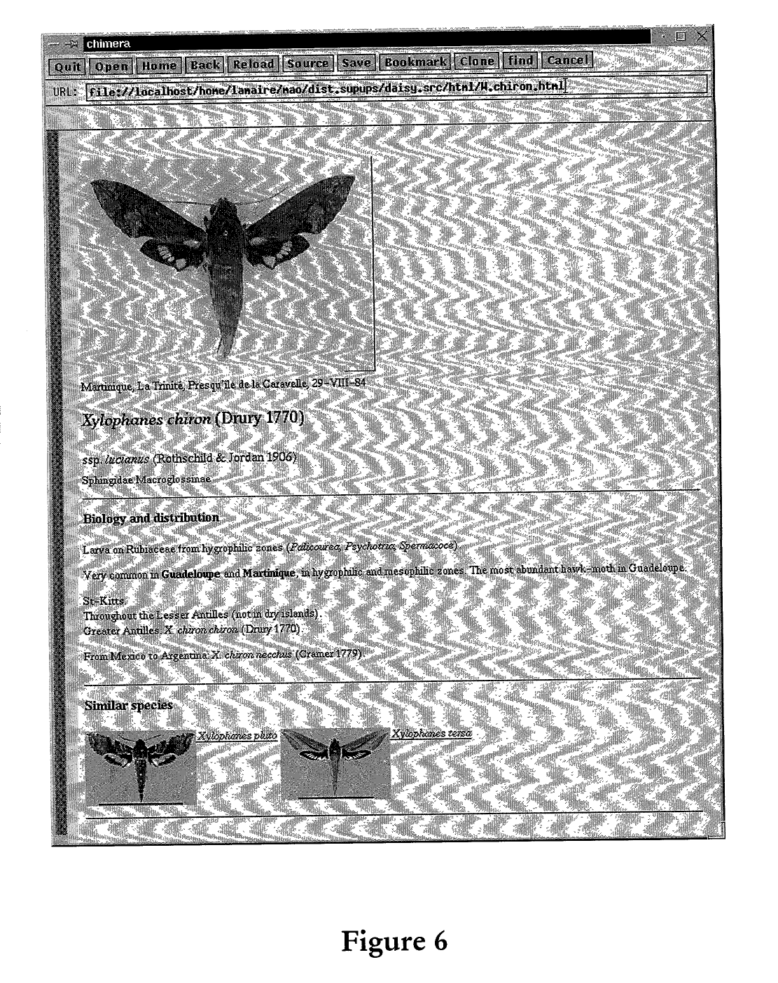

FIG. 6 illustrates a typical DAISY information web page. Such an informational web page may be provided as part of an initial data set for instruction, identification, and teaching purposes.

The following is a description of the schemas for DAISY NNC correlation algorithms and pose invariance algorithms alluded to above. The classification algorithm utilized by the DAISY system may be based on an extension of the Nearest Neighbor Correlation (NNC) algorithm first proposed by Alexander and Stonham (previously incorporated by reference) and later used in their Wisard face recognition system. The algorithm as it is described here also incorporates enhancements suggested by Lucas, also previously incorporated herein by reference.

From the standpoint of modular extensible pattern recognition systems like DAISY, the NNC approach offers a number of advantages over more conventional classifiers such as Artificial Neural Nets (ANN's). The NNC approach is inherently modular. Most ANN and PCA (Principal Component Analysis) based trainable identification schemes may be non-modular. Pattern vectors which correspond to objects which are to be classified may be transformed into a low dimensionality space (e.g., the eigenspace of a PCA description). Typically, the mapping between the input pattern vectors and the low dimensionality representational space may be highly non-linear.

Thus, the computational cost of re-computing the representational space when new material is added to the space is relatively high. While this is not a problem for many potential application areas (e.g., identification of printed circuit board components, such as disclosed in Cootes T. F, G. J Page, C. B. Jackson and C. J. Taylor, Statistical grey level models for object location and identification, Proc Brit. Machine Vis. Conf. Ed: D. Pycock, ISBN 0-9521898-2-8, 1995, incorporated herein by reference) it may be a problem for systems like DAISY whose training space is liable to be both large and temporally variant.

NNC is a method of choice if the object classes which are to be discriminated have associated pattern vector distributions which are not linear functions in pattern vector space. This is almost certainly the case for many of the object classes DAISY is called upon to discriminate, in particular, biological objects where there is much inter-class pattern overlap, and which possess complex pattern vector distribution topologies.

NNC methodologies are simple and elegant. As a consequence they are simple to code and maintain, and are fast in both training and identification modalities. Because NNC algorithms are so simple and intuitive they may be readily implemented directly in hardware should the need arise.

A Pascal-like pseudocode fragment for the core NNC algorithm used by DAISY is given below. This may be a direct implementation of continuous n-tuple version of the algorithm proposed by Lucas. The following pseudocode illustrates a function for continuous n-tuple NNC classifier (as used by DAISY):

// Continuous N-tuple NNC classifier as used in the DAISY
// pattern recognition system. Note entities like ts_image
// and best_image are implicit aggregates (e.g., structures
// which contain both the pattern vector and ancillary
// information which pertains to it
function nnc_correlate(unknown_image)
begin

// Initialize best correlation value to the lowest
// possible value supported by the current hardware.
// If “best” correlation was a minimum (as opposed to
// a maximum needed to initialize to MAX_FLOAT.
initialize corr MIN FLOAT
for ts_image := all_images_in_training set do

corr := correlate(unknown_image,ts_image)
// becomes corr < best_corr if best correlation
// is a minimum.
if (corr > best_corr) then

best_corr := corr;
best_image := ts_image;

endif

end
// Return aggregate corresponding to image in
// training set which correlates most strongly
// with the unknown image.
return best_image;

end

Although the NNC schema given above possesses distinct advantages (over ANN and PCA based classification methods for modular systems dealing with non-linearly distributed pattern vector data, one critical element within the NNC schema is the function correlate which computes the pair-wise correlation coefficient between the unknown image and the images within the training set. A poor choice of algorithm for correlate may result in a classifier system whose overall performance is poor.

Lucas proposes a conventional cross-correlation approach, which tends to perform indifferently when presented with object classes whose corresponding pattern vectors have a complex distribution in pattern vector space. The problem with a cross-correlation approach is than it implicitly tends to look for similarities between pattern vectors. The N approach of the present invention, on the other hand, looks for differences between pattern vectors.

After conducting experiments with a number of pair-wise correlation schemes, including cross correlation, the present inventors have discovered, empirically, a Normalized Vector Difference (NVD) algorithm which is given in pseudocode below, tends to perform best when presented with complex pattern data. A statistically robust form of correlation, Normalized Vector Difference algorithm is used to correlate an unknown image with the training set images. Empirically, it has been shown that this form of correlation is much more robust with respect to noise than conventional correlation techniques which are based upon cross-correlation algorithms. The following pseudocode illustrates a schema for Normalized Vector Difference (NVD) algorithm:

// Normalized vector difference [NVD] algorithm
function nvd_corr(vector_1, vector_2)
begin
initialize sum_to_zero;
initialize cnt_to_zero;
// Normalize input pattern vector 1
for component := all_components_in_vector_1 do

sum := sum + sqr(component);
increment cnt;

end
sum := sum / cnt;
for component := all_components_in_vector_1 do

component := component / sum;

end
// Normalize input pattern vector 2
initialize sum_to_zero;
initialize cnt_to_zero;
for component := all_components_in_vector_2 do

sum := sum + sqr(component);
increment cnt;

end
sum := sum / cnt;
for component := all_components_in_vector_1 do

component := component / sum;

end
// Do vector difference comparison
initialize sum_to_zero;
for component_1 := all_components_in_vector_1 do

for component_2 := all_components_in_vector_2 do

sum := sum + abs(sqr(component_2) − sqr(component_1));

end

end
// permissible as the pattern vectors were normalized
// before the vector difference comparison.
return 1.0 − sum;

end

In order to ensure that DAISY fails gracefully when presented with an object it cannot resolve, modifications have been made to the continuous n-tuple NNC algorithm as given in the pseudocode above to yield the multi-NNC algorithm. Rather than giving a scalar correlation coefficient, the multi-NNC returns a vector V which is composed of the ordered set of the maximum correlation coefficients of the top N classes to the unknown pattern. Traversal of this pattern vector may yield the most likely identity for the unknown object in order of likelihood. This sort of classification metric is invaluable when identifying biological objects which may be very closely related and therefore morphologically very similar A pseudo code fragment for the multi-NNC algorithm is given below. The following pseudocode illustrates a schema for mult-NNC algorithm used by the DAISY exemplar. Certain implementational details have been omitted for the sake of clarity:

// DAISY multi-NNC algorithm implementation
function multi_nnc(unknown_image)
begin

// Initialize data structures which hold
// value of strongest correlation between a
// a member of a given class and the unknown
// pattern vector. In addition some ancillary
// data (e.g., the name of the class) is also
// held in this data structure.
for class := all_classes_in_training_set do

initalize class_best_corr_data;

end
// Find strongest correlation for all classes of object
// for simplicity the code to store the best N classes
// in the class_best_corr_data structure has been omitted
// Effectively N==C here, where C is the number of classes.
// if N < C drop the worst class if its best correlation
// coefficient is < corr.
for class := all_classes_in_training_set do

ts_images := all_ts_images_in_class
// NNC correlation using NVD pair-wise correlation
corr := nnc_correlate(unknown_image,ts_images);
// Update correlation data for current class
update class_best_corr_data(class, corr);
end

end
// Use quicksort algorithm to sort data.
quicksort. class_best_corr_data;
// List of classes in “best correlation coefficient” order
return class_best_corr_data;

end

Note that an example of the quicksort algorithm may be found, for example, in Press W. H, B. P. Flannery, S. A Teukolsky, and W. T Vetterling, Numerical recipes in C: The art of scientific computing, Cambridge University Press, Edn. 1, ISBN 0-521-35465-X, 1988, incorporated herein by reference.

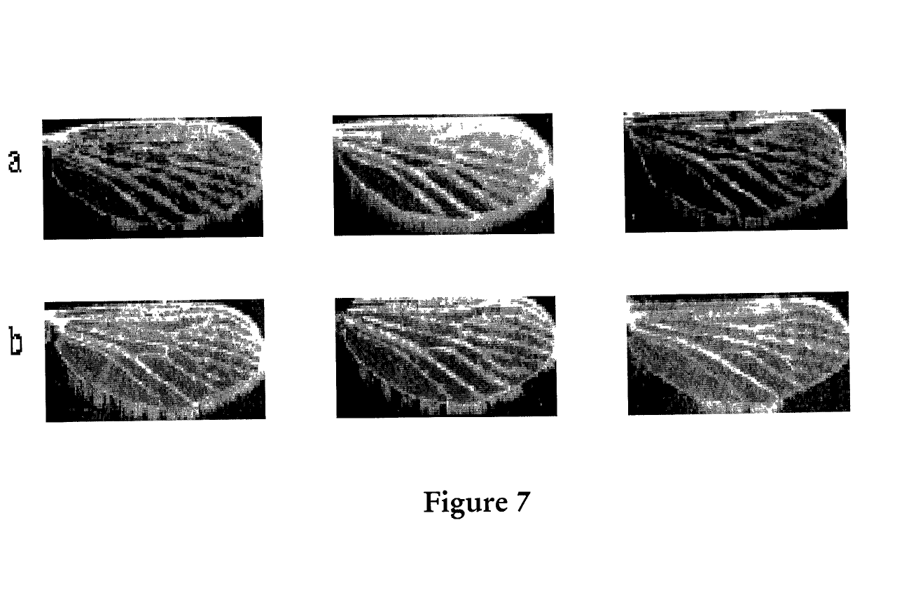

FIG. 7a illustrates wings of Culex pipiens pipiens (Linaeus) and FIG. 7b illustrates various wings of Culex pipiens molestus (Forskal). These sub-species of Culex pipiens are very closely related, and not separable by taxonomists using morphological characters. Small statistical differences in the distributions of the wings of these taxa in morph space permit DAISY to separate the (with 80% certainty given 5 training examples per taxa).

The function for an ideal IPM pose normalization algorithm is to pre-process pattern vectors (images), removing the effects of rotation and scale before they are presented to a classification system such as DAISY either as an unknown (which is to be classified), or as training data. In practice, the most efficient way of dealing with the scale part of the problem is to define a Region Of Interest (ROI) using the data capture tool (e.g., DFE in the case of DAISY) and then to normalize that. The rotational part of the problem may be solved elegantly by converting the image representation from Cartesian co-ordinates to polar co-ordinates, and then taking the (wrap around) auto-correlation function of the resulting pattern vector. Pseudo code for this operation is given below. The following pseudocode illustrates a schema for whole image IPM. For the sake of clarity a whole image autocorrelation version of the algorithm is given. In practice version of the algorithm which autocorrelate successive radial strips are better for discrimination tasks:

// IPM pose normalization functionality
function ipm(fovea, Cartesian_image, tstep, rstep)
begin

// Convert Cartesian co-ordinated to Polar. The fovea defines
// the origin of the polar co-ordinate system. Usually, the
// center of a ROI which defines the region containing the
// containing the object data.
// Note sub-sampling to a grid of stepsize tstep in the
// the theta (angular) dimension and rstep in the radial
// dimension. This process also provides values for the
// number of azimuthal bins (used when computing
// correlation function)
polar_image := Cartesion_image to_polar_image(fovea,

Cartesian_image,

tstep,
rstep);

// Take the (wrap around) autocorrelation function of
// the polar image. Step over all azimuthal bins.
initialize next_to_zero;
for theta := next_theta_bin do

// Correlate the image with an image which is the image
// rotated right (or left) circularly by theta bins.
outvec[next] :=cross_correlate(polar_image,polar_image_lead_theta);
increment next;

end
return outvec

end

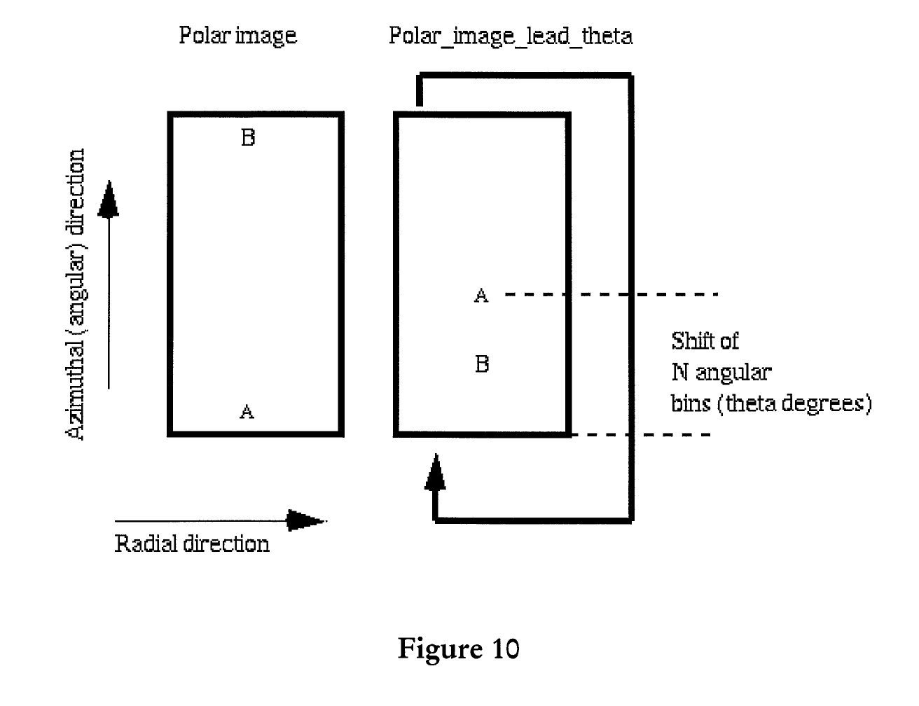

It should be noted that the whole image auto correlation algorithm given in psuedocode form here is only one of a larger class of auto correlation algorithms. In practice, algorithms which auto correlate each radial strip in the (polar) image tend to give better resolution for discrimination tasks than the form of the algorithm given above. A definition of this radial strip is illustrated in FIG. 10.

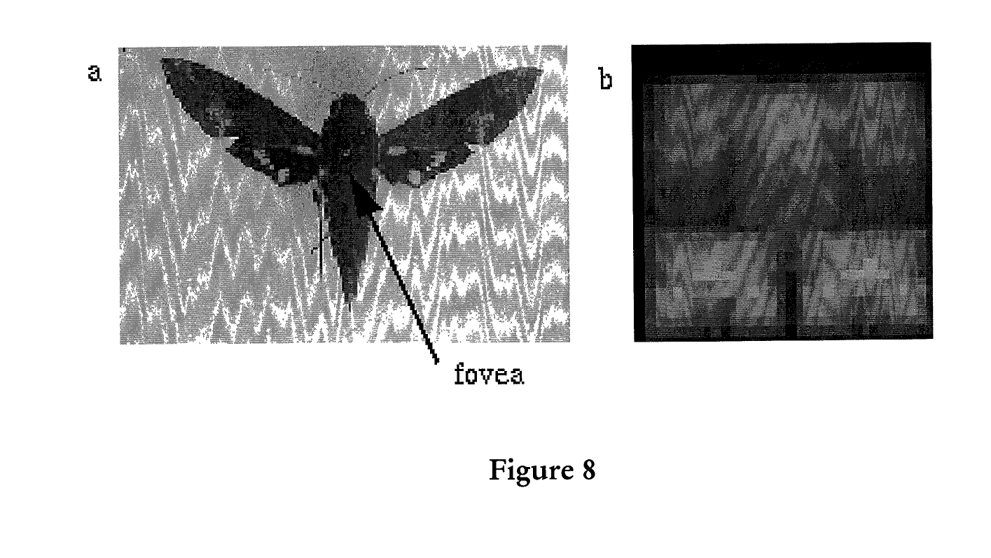

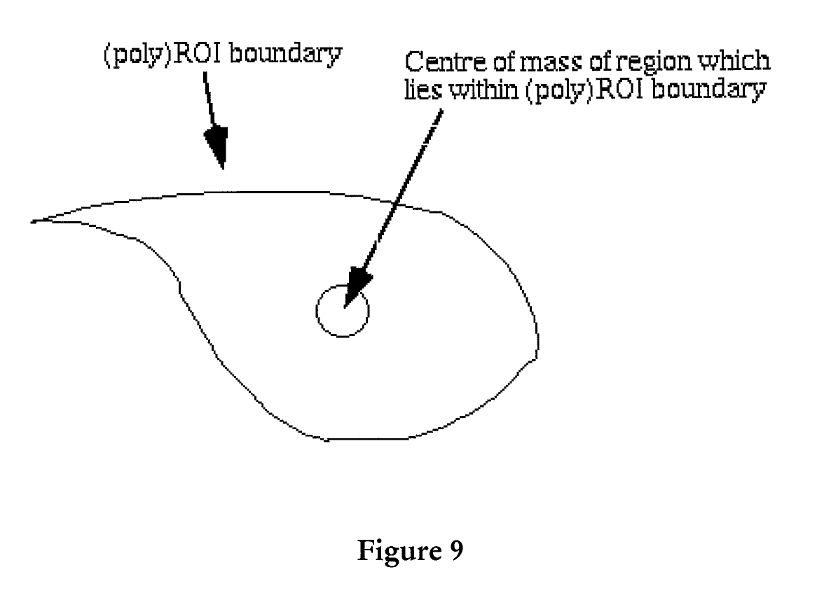

FIG. 3 illustrates a specimen of Xylophanes chiron (Drury) a) and its subsampled IPM transform b). In this case the fovea is the center of image a. Each specimen to be identified may be mounted on a microscope stage or other imaging device and the image input into the DAISY system as discussed above. Next, an outline of the object may be obtained as discussed below in connection with FIG. 9. The outline may be used to separate the object from its background. Next, the object image is converted from rectangular cartesian polar coordinates to rectangular polar coordinates. Finally, the autocorrelation function is computed along the angular direction in polar space. The resulting IPM transform image is illustrated in FIG. 8b.

The IPM transform image may then be compared to other stored IMP transform images in the training set database. Correlation between the sample image and the stored image (e.g., on a pixel by pixel basis) may then be generated. The stored image having the highest correlation may be deemed to be a “match” to the sample image. Alternately, a range of images may be displayed, with their corresponding correlation factors, in order from most probable to least probable. A user may then view the various possible matches to determine final classification.

FIG. 9 illustrates the relationship between (poly)ROI and is fovea (for IPM algorithm). The area enclosed by the (poly)ROI is the region of interest containing the unknown or training object. Typically, this is an insect wing in the case of DAISY. The marked circle is one of the radial image strips which is autocorrelated in order to produce a pose independent object signature.

A schematic of an input image (with fovea) is illustrated in FIG. 9, and a schematic of the circular rotation operations (used to apply lead or lag) prior to auto correlation is illustrated in FIG. 10. In should be further noted that the pose invariant vectors could also be generated by using methods other than autocorrelation. One could, for example, generate a histogram which bins a pairwise function of the brightness of pairs of pixels within a given radial strip as a function of their radial separation. For example, one could bin a normalized multiplicative brightness product as a function of radial separation. Experimental results have indicated that while IPM does indeed generate pose independent pattern vectors it tends to degrade resolution. It is more difficult for the pattern matcher to differentiate IPM images than it is for it to resolve the (resampled) Cartesian imagery from which the IPM pattern vectors were derived. Recent research by Thacker et al (1996) leads us to believe that one may attain pose invariance with better resolution using histograms of the sort alluded to here.

FIG. 10 illustrates the concept of a circular image rotation in the contact of IPM autocorrelation. Although the pseudocode illustrated above specifies a whole image correlation, auto correlation may also be done on (radial) image strips or even individual pixels with minor changes to the overalls algorithm design. Note a radial strip is a sub-segment of an image that is one radial bin wide in the azimuthal direction (e.g., between A and B in the polar image as illustrated in FIG. 10).

The use of the NVD algorithm is one key to the operational success of the DAISY system. The particular form of the algorithm may take the form of sqr(Aij)-sqr(Bij)), where Aij and Bij are corresponding pixels in a pair of images which are to be compared. The algorithm is very sensitive to small differences between very similar images in a way which standard cross-correlation measures are not. In this sense it is similar in sensitivity to non-parametric correlators (e.g. Kendalls' tau). Its major advantage over algorithms such as Kendalls' tau, however, lies in the fact that its speed of execution is several orders of magnitude faster on the same computer hardware.

IPM transforms input imagery into pose-independent pattern vectors. However, auto-correlation of the radial strips tends to degrade the performance of the pattern classifier. While this degradation does not seriously affect the performance of the system when presented with patterns which are significantly different, it is significant when the system is trying to classify pattern vectors which differ by only a few percent. One alternative to auto-correlation is to use methodologies which do not suffer from this sort of degradation. One alternative approach is to take an image and then compute a function of brightness of pixels at (Cartesian) locations [i,j] and [l,m]:

F=A[i,j]*A[l,m]

and expresses it as a function of the radial separation:

S=sqrt(sqr(k−i)+sqr(l−j))

Thus, the input image may be replaced by a pattern vector F(S) which has the property of pose invariance: as in the case of the IPM approach, both training images and unknowns are transformed prior to processing by the DAISY classifier.

The PDS transport schema may be required in order for the DAISY system to be of any practical use as a biological screening tool. The DAISY system may need to be capable of processing thousands of training sets, containing tens of thousands of specimens in order to identify an unknown. Effectively, this means that DAISY had to be designed from scratch as a scaleable parallel system. Although many of the services required by such a system were available from either the pre-existing PUPS libraries, the Tennessee Checkpointing Library or the MOSIX parallel POSIX kernel extensions, one significant problem, how to implement a scaleable data transport between co-operating processes (which may be resident on different processors) remained unsolved.

In order to maximize the flexibility of the DAISY system and to make optimal use of the resources within a parallel computer, or a distributed computing cluster, the data transport mechanism may need to be dynamically scalable. For example, if a new processor becomes available within a computing cluster the transport mechanism may need to be able to make use of DAISY processes running on this new resource without disrupting the activities of other DAISY processes running elsewhere within the cluster. Traditionally, co-operating processes in clustered or parallel computing environments exchange data using some form of message passing mechanism (e.g., via a FIFO such as a pipe or a socketpair).

For example, PVM developed by the University of Tennessee and Oak Ridge National Laboratory (Geist A, J. Beguelin, J. Dongarra, W. Jiang, R. Manchek and V. Sundernam, PVM: Parallel virtual machine, MIT Press, Cambridge Mass., 1994, incorporated herein by reference), MPI (Gropp W, E. Lust and A. Skjellum, Using MPI: Portable parallel programming with the message passing interface, MIT Press, Cambridge Mass., 1994, incorporated herein by reference), and Beowulf (Ridge D, D. Becker, P. Merkey and T. Sterling, Beowulf: harnessing the power of parallelism in a pile of PC's, Proc. IEEE Aerospace, 1997, incorporated herein by reference) are all examples of a systems of this sort. One major problem with this sort of approach is its inherent lack of dynamic scaleability. Once a network topology is in place, it is difficult to change that topology dynamically without incurring a significant computational overhead.

There are transport systems in existence which achieve the transparent low overhead scaleability required by scaleable parallel systems like DAISY. Examples of such systems may be found in the biological realm. Multicellular living organisms find themselves faced with an almost identical transport problem: products produced by one group of cells may have to be transported to a distant group of cells without incurring significant energetic overhead. In addition, this mechanism may need to remain efficient if more cells are added to the organism when it grows.

The biological solution to this transport problem is simple and elegant. Proteins to be delivered to a cell at a remote site are placed in the bloodstream, and marked with a chemical signature which causes the remote cell to bind the item and transport it through its cell wall. A similar mechanism may be set within the digital domain. Here cells are replaced by processes, proteins become files, the bloodstream becomes a low latency network file system such as Andrew or MFS, and the chemical signature becomes a digital signature associated with the file (e.g., a CRC signature, UNIX magic number etc). Pseudocode for this transport mechanism is given below. The following pseudocode illustrates schemas for SDS transmitter and receiver:

// SDS transmitter. Item is the data which
// is to be transmitted (any type)
function sds_transmit(item, signature)
begin

// Sign data with unique signature which identifies
// the destination process. Not interested
// in where the process is only what it is here.
signed_item := sign(item, signature);
// Write data to low latency network filesystem.
// That is all need be done if the transmitter
write_to_nfs(signed_item);

end
// SDS receiver. The receiver is more complex than the
// transmitter. It is also active: the receiving process
// is constantly scanning the filesystem for items which
// match its input digital signature. If one is found,
// it is dragged into the process and processed. In
// practical implementations the SDS receiver has its
// own (low priority) thread of control.
function sds_receive
begin

do forever

// Check filesystem for new files. If a new
// file has arrived does it have my name on
// it?
if (new_file_arrived_in_nfs) then

new_item := read_from_nfs(item);
signature := get_signature(new_item);
// It has my name on it. Tell payload processing
// thread its got to earn its living and do some
// work!
if (signature == my signature) then

signal (new_data_arrived);

endif

endif

end

end

The function of the training set pruning algorithm is to optimally select images from a training pool of imagery which has been identified by an expert in the class of objects which have been imaged in order to generate the training pool. The distribution of the training images corresponding to a given class of objects forms a non linear function in a morph space (typically of very high dimensionality).

For this reason, generating an optimal training set may be an inherently non-linear optimization problem. Initially, an attempt may be made to generate optimal object class training sets using a stochastic algorithm based on cumulative evolution. A pseudo code fragment for this algorithm (written in a Pascal-like block structured language) is given below:

// Generate training set composed of N images randomly
// selected from the training pool.
generate_random_training_set_of_size(N):
// Initialize counters
initialize identifications_correct_to_zero;
initialize prev_identifications_correct_to_zero;
// Initialize storage which may be used to store the
// (image names) of those images which comprise the
// best training set. Initially, this may be the
// random training set generated above.
initialize best_training_set;
do forever

// Get (random) operation to be performed on training set.
get_random_opeperation_type;
caseof operation_type

delete: remove_random_image from_training_set;
add: add_random_image to_training_set_from_training_pool;
swap: swap_random_training_set_image_with_random_training_pool_image;

endcase
// Compute the fitness of the current (e.g., next) training set
for tpool_image := all_images_in_training_pool do

nnc_correlate(tpool_image,training_set);
update(identifications_correct;

end
// Is the fitness of the current training set greater than that of
// the best training set. If it is, the current training set becomes
// the best training set.
if(identifications_correct > prev_identifications_correct) then

set prev_identifications_correct := identifications_correct,
save_best_training_set;

else

// If not restore current best training set. May be needed
// to ensure point mutation which may result in optimal search
// of the training space.
restore_best_training set;

endif

enddo

The above psuedocode fragment for continuous cumulative evolution of an optimal training set. Training set size, N is an implementation defined constant. Subsequent extensive testing has verified that it is possible to generate optimal training sets using cumulative evolutionary approaches similar to the one shown in the pseudocode illustrated above. The principal problem with these sorts of approaches are they are far too slow for any practical commercial package. A better solution is afforded by another stochastic algorithm which may be termed the Maximization Of VariancE algorithm or MOVE.

The principal advantage of the MOVE algorithm is it greatly reduces the number of training pool/training set correlations required to optimize the training set. This means that DAISY implementations equipped with MOVE may tend to generate optimized training sets (and therefore improve their performance) faster than those equipped with the simple continuous cumulative optimization algorithm. The following pseudocode illustrates implementation of MOVE algorithm. Note that this algorithm is much more concise than the continuous cumulative optimization algorithm shown in the pseudocode above. Training set size, N is an implementation defined constant:

// Initial training set (N images) is composed of images which
// have been randomly selected from the training pool
generate_random_training_set_of_size (N);
do forever

// Get a random image from the training pool which may
// be inserted into the training set if lies on or near
// to a morph class boundary
tp := select_random_training_pool_image;
ts_1 := find_strongest_nnc_correlation_in_tset(tp);
ts_2 := find_next_strongest_nnc_correlation_in_tset(tp);
// Does the strongest correlation lie within a region of
// of morph space whose class is homogenous?
if(class(ts_1) != class(tp) && class(ts_2) != class(tp)) then

c1 := nvd_correlation(ts_2,tp);
c3 := nvd_correlation(ts1,ts2);
if(c3 < c1) then

// Image lies on or near a morph class boundary and is
// significant. Therefore add it to training set
add_tp_to_training_set

endif

endif

enddo

Effectively the MOVE algorithm adds imagery from the training pool if and only if the added image lies at the boundary between two classes in morph space. Imagery which lies within regions which are homogenous for a given class are not added to the training set as doing this would reduced the speed of DAISY NNC computation without effecting the outcome.

The following is a schema for testing system accuracy with a given training set, and building partitioned classifiers. In a practical implementation of the DAISY system, it is important to be able to assess the classification accuracy for given classes of objects and training sets. In order to accomplish this the identity of the contents of the training pool may be assumed to be unknown. The accuracy of the corresponding training set may then be assessed by attempting to identify each member of the training pool and then seeing whether the DAISY classification agrees with that of the expert. At a simplistic level, for a given set of training pool objects belonging to a class {C}, this methodology allows to compute the percentage of members of {C} which are correctly identified.

This is the so called First Past The Post [FPTP] statistic described in O'Neill M. A, I. D. Gauld, K. J. Gaston and P. J. D. Weeks, DAISY: An automated invertebrate identification system using holistic vision techniques, Proc. Inaugural meeting of BioNet-International Group for Computer Aided Taxonomy [BIGCAT], Published by BioNet-International Technical Secretariat [TECSEC], Bakeham Lane, Egham Surrey, TW20 9TY, UK, 1999, and incorporated herein by reference.

Note that this article discloses an earlier version of the DAISY system using a PCA (See, e.g., Turk, M. and A. Pentland, Eigenfaces for recognition, J. Cog. Neuro. 3, 71-86, 1991, incorporated herein by reference) for methods of correlating. This article did not disclose the present invention which uses NNC methods with cumulative training set optimization. The FPTP statistic provides a user with rough indication of how well the system is able to classify {C}. It is possible to further analyses the performance of DAISY by analyzing the corresponding mis-identifications.

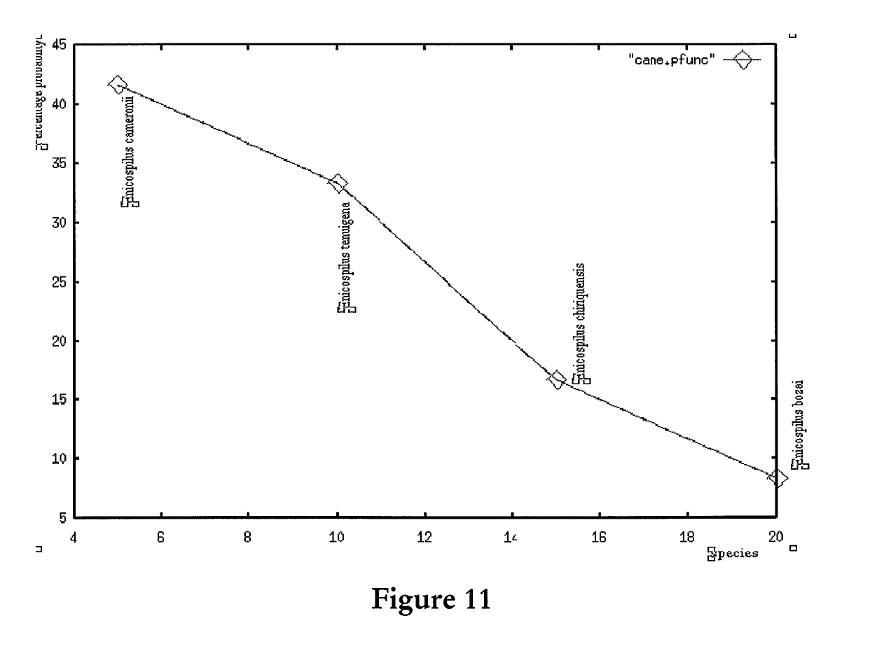

FIG. 11 illustrates an actual (mean) classifier partition function for Enicospilus cameronii (Dalla Torre). Any unknown X which correlates most strongly to this classifier has an a priori probability of 41.7% of being Enicospilus cameronii, a 33.3% probability of being Enicospilus teniuigena (Kriechbaumer), a 16.7% probability of being Enicospilus chiriquensis (Cameron) and an 8.3% probability of being Enicospilus bozai (Gauld).

The a priori probability of it being any other species is less than 1%. Qualitatively similar partition function arise in the case of the 300+ species so far screened using DAISY. Enicospilus is a genus of ophinine ichnumonid from tropical Mesoamerica, the members of which are very difficult to separate using morphological characters (See, e.g., Gauld I. D, A survey of the ophininae of tropical Mesoamerica with special reference to the fauna of Costa Rica, Bull. Brit. Mus. Nat. Hist, 57(1), 1988, incorporated herein by reference).

This analysis leads to a set of prior probabilities which describe the probability of an unknown X being classified as a member of one or more of the training set classes. This classifier partition function is potentially very useful. It can be independently computed for each member of each training set, and once computed the partition probabilities can be sorted into descending order. This means that if an unknown X happens to be most strongly (NNC) correlated with some training set image T, the partition function may be used to decide the most likely classification of X.

In fact, the partition function may provide more than simply deciding the most likely classification of X. Traversing the partition function, the next most likely classification can be found, and so on. Effectively, the classifier partition function has list-order properties (which are useful for screening tasks). However, unlike the non metric list ordering algorithm used by the basic multi-NNC (as set forth below) the (prior) probabilities associated with each item in the list are meaningful. This means that partition functions are superior to multi-NNC, if one wishes to classify object outright, as opposed to merely screen them. A pseudocode fragment for per-training set image partition function generation is given below. The following pseudocode describes (per training set image) partition function generation:

// Note that this psuedocode schema computes the partition
// function for each image in the training set. This is better
// than computing the global partition function for each
// object class in terms of ease and speed of implementation.
for tset_image := all_images_in_training_set do

initialize_partition_count(tset_image),

end
for tset_image := all_images_in_training_set do

for tpool_image := all_images_in_training_pool

if(tset_image 1 = tpool_image) then

tp := find_strongest_correlation(tset_image,tpool_image);
update_partition_count_of_tset_image(tp,tset_image);

endif

end

end
compute_classifier_partition_percentages(tset_image);

While the preferred embodiment and various alternative embodiments of the invention have been disclosed and described in detail herein, it may be apparent to those skilled in the art that various changes in form and detail may be made therein without departing from the spirit and scope thereof.

We claim:

1. A system for identifying and classifying images, comprising:
a training set comprising a plurality of sample image pose normalized images;
means for inputting an input image to be classified or identified and storing the input image;
an image pose normalizer for image pose normalizing the input image to produce an image pose normalized input image;
means for comparing the image pose normalized input image to each of the plurality of sample image posed normalized images; and
means for displaying at least one of the plurality of sample images which most closely corresponds to the input image.

2. The system of claim 1, wherein said means for comparing the image pose normalized input image to each of the plurality of sample image posed normalized images comprises:
a Normalized Vector Difference (NVD) algorithm, for determining differences between the image posed normalized input image and the plurality of sample image posed normalized images.

3. The system of claim 2, wherein said training set comprising a plurality of image pose normalized images is generated from a training set including a plurality of sample images pre-processed to remove effects of rotation and scale.

4. The system of claim 3, wherein said training set comprising a plurality of image pose normalized images is further generated by defining a region of interest in each of the plurality of sample images and normalizing the region of interest for each of the plurality of sample images.

5. The system of claim 4, wherein said training set comprising a plurality of image pose normalized images is further generated by converting an image representation for each of the plurality of sample images from Cartesian coordinates to polar coordinates to produce a corresponding plurality of sample image pose normalized image for each of the plurality of sampled images.

6. The system of claim 5, wherein said image pose normalizer for image pose normalizing the input image comprises:
means for by processing to remove effects of rotation and scale by defining a region of interest in the input image.

7. The system of claim 6, wherein said image pose normalizer for image pose normalizing the input image further comprises:
means for normalizing the region of interest for the input image.

8. The system of claim 7, wherein said image pose normalizer for image pose normalizing the input image further comprises:
means for converting the input image representation from Cartesian coordinates to polar coordinates to produce an image pose normalized input image.

9. A method for identifying and classifying images, comprising the steps of:
generating a training set comprising a plurality of sample image pose normalized images;
inputting an input image to be classified or identified and storing the input image;
image pose normalizing, using an image pose normalizer, the input image to produce an image pose normalized input image;
comparing the image pose normalized input image to each of the plurality of sample image posed normalized images; and
displaying at least one of the plurality of sample images which most closely corresponds to the input image.

10. The method of claim 9, wherein said step of comparing the image pose normalized input image to each of the plurality of sample image posed normalized images comprises the steps of:
determining, using a Normalized Vector Difference (NVD) algorithm, differences between the image posed normalized input image and the plurality of sample image posed normalized images.

11. The method of claim 10, wherein said step of generating a training set comprising a plurality of image pose normalized images comprises the step of:
generating, from a training set, a plurality of sample images pre-processed to remove effects of rotation and scale.

12. The method of claim 11, wherein said step of generating a training set comprising a plurality of image pose normalized images further comprises the steps of:
defining a region of interest in each of the plurality of sample images, and
normalizing the region of interest for each of the plurality of sample images.

13. The method of claim 12, wherein said step of generating a training set comprising a plurality of image pose normalized images further comprises the step of:
converting an image representation for each of the plurality of sample images from Cartesian coordinates to polar coordinates to produce a corresponding plurality of sample image pose normalized image for each of the plurality of sampled images.

14. The method of claim 13, wherein said step of image pose normalizing the input image comprises the step of:
processing to remove effects of rotation and scale by defining a region of interest in the input image.

15. The method of claim 14, wherein said step of image pose normalizing the input image further comprises the step of:
normalizing the region of interest for the input image.

16. The method of claim 15, wherein said step of image pose normalizing the input image further comprises the step of:
converting the input image representation from Cartesian coordinates to polar coordinates to produce an image pose normalized input image.

17. A method for identifying and classifying images, comprising the steps of:
inputting an input image to be classified or identified and storing the input image;
image pose normalizing, using an image pose normalizer, the input image to produce an image pose normalized input image;
comparing the image pose normalized input image to each of a plurality of sample image pose normalized images in a stored training set comprising the plurality of sample image posed normalized images; and
displaying at least one of the plurality of sample images which most closely corresponds to the input image.

18. The method of claim 17, wherein said step of comparing the image pose normalized input image to each of the plurality of sample image posed normalized images comprises the steps of:
determining, using a Normalized Vector Difference (NVD) algorithm, differences between the image posed normalized input image and the plurality of sample image posed normalized images.

19. The method of claim 18, wherein the training set comprising a plurality of image pose normalized images is generated by:
generating, from a training set, a plurality of sample images pre-processed to remove effects of rotation and scale.

20. The method of claim 19, wherein the training set comprising a plurality of image pose normalized images is further generated by:
defining a region of interest in each of the plurality of sample images, and
normalizing the region of interest for each of the plurality of sample images.

21. The method of claim 20, wherein the training set comprising a plurality of image pose normalized images is further generated by:
converting an image representation for each of the plurality of sample images from Cartesian coordinates to polar coordinates to produce a corresponding plurality of sample image pose normalized image for each of the plurality of sampled images.

22. The method of claim 21, wherein said step of image pose normalizing the input image comprises the step of:
processing to remove effects of rotation and scale by defining a region of interest in the input image.

23. The method of claim 22, wherein said step of image pose normalizing the input image further comprises the step of:
normalizing the region of interest for the input image.

24. The method of claim 23, wherein said step of image pose normalizing the input image further comprises the step of:
converting the input image representation from Cartesian coordinates to polar coordinates to produce an image pose normalized input image.

25. A computer-readable media containing a series of program instructions for controlling the computer for identifying and classifying images, said program instructions comprising:
an instruction for an instruction for inputting an input image to be classified or identified and storing the input image;
an instruction for image pose normalizing, using an image pose normalizer, the input image to produce an image pose normalized input image;
an instruction for comparing the image pose normalized input image to each of a plurality of sample image pose normalized images in a stored training set comprising the plurality of sample image posed normalized images; and
an instruction for displaying at least one of the plurality of sample images which most closely corresponds to the input image.

26. The a computer-readable media containing a series of program instructions for controlling the computer of claim 25, wherein said instruction for comparing the image pose normalized input image to each of the plurality of sample image posed normalized images comprises:
an instruction for determining, using a Normalized Vector Difference (NVD) algorithm, differences between the image posed normalized input image and the plurality of sample image posed normalized images.

27. The a computer-readable media containing a series of program instructions for controlling the computer of claim 26, wherein the training set comprising a plurality of image pose normalized images is generated by:
generating, from a training set, a plurality of sample images pre-processed to remove effects of rotation and scale.

28. The a computer-readable media containing a series of program instructions for controlling the computer of claim 27, wherein the training set comprising a plurality of image pose normalized images is further generated by:
defining a region of interest in each of the plurality of sample images, and
normalizing the region of interest for each of the plurality of sample images.

29. The a computer-readable media containing a series of program instructions for controlling the computer of claim 28, wherein the training set comprising a plurality of image pose normalized images is further generated by:
converting an image representation for each of the plurality of sample images from Cartesian coordinates to polar coordinates to produce a corresponding plurality of sample image pose normalized image for each of the plurality of sampled images.

30. The a computer-readable media containing a series of program instructions for controlling the computer of claim 29, wherein said instruction for image pose normalizing the input image comprises:
an instruction for processing to remove effects of rotation and scale by defining a region of interest in the input image.

31. The a computer-readable media containing a series of program instructions for controlling the computer of claim 30, wherein said instruction for image pose normalizing the input image further comprises:
an instruction for normalizing the region of interest for the input image.

32. The a computer-readable media containing a series of program instructions for controlling the computer of claim 31, wherein said instruction for image pose normalizing the input image further comprises:
an instruction for converting the input image representation from Cartesian coordinates to polar coordinates to produce an image pose normalized input image.
